(19) United States
(12) Patent Application Publication
(10) Pub. No.: US 2021/0059218 A1
(43) Pub. Date: Mar. 4, 2021

(54) HYDRATING LEASH FOR PETS AND METHODS OF FORMING SAME

(71) Applicants: Jordan Benning, Orange, NJ (US); Perri Whitaker, Maplewood, NJ (US)

(72) Inventors: Jordan Benning, Orange, NJ (US); Perri Whitaker, Maplewood, NJ (US)

(21) Appl. No.: 17/005,459

(22) Filed: Aug. 28, 2020

Related U.S. Application Data
(60) Provisional application No. 62/894,719, filed on Aug. 31, 2019.

(51) Int. Cl. A01K 27/00; A01K 7/00

(52) U.S. Cl. CPC A01K 27/008; A01K 7/00; A01K 27/003; A01K 27/005

(57) ABSTRACT

A hydrating leash includes a flexible inner tubing having a closed end and an open end, the inner tubing including a threaded coupler at the open end, an outer fabric sleeve disposed over the flexible inner tubing, a handle unitarily formed with a screwtop having an internal thread configured to mate with the threaded coupler, and an attachment mechanism coupled at a first end to the outer fabric sleeve and configured to couple to a pet's collar at a second end.

### CROSS-REFERENCE TO RELATED APPLICATIONS

This application claims the benefit of U.S. Provisional Application Ser. No. 62/894,719, filed on Aug. 31, 2019, the contents of which are hereby incorporated by reference in its entirety as if fully set forth herein.

### FIELD OF THE DISCLOSURE

The present disclosure relates to devices for pets. More particularly the present disclosure relates to hydrating leashes for pets and methods of making same.

### BACKGROUND OF THE DISCLOSURE

Recreation is important for a pet's health, and pet owners often take their pets for frequent walks. When doing so pet owners may encounter certain challenges. For example, dog owners encounter issues associated with satisfying a dog's thirst when dog and owner are away from the dog's water bowl, e.g., when on a walk or engaged in athletic/recreational activities. It is often inconvenient and/or impractical when not at home to bring along and set up a bowl or some other container from which a pet can drink. While naturally occurring sources of fluid refreshment are sometimes available, e.g., fountains, ponds, puddles and the like, more frequently pet owners are left to their own ingenuity in attempting to address their dog's thirst when remote from the home-based water bowl. Additionally, pet owners may not want to carry a bulky water bottle or other container in their hands.

Thus, a need remains for a drinking aid for use with pets, e.g., dogs, that may be readily utilized and that can be conveniently transported.

### SUMMARY OF THE DISCLOSURE

In some examples, a hydrating leash includes a flexible inner tubing having a closed end and an open end, the inner tubing including a threaded coupler at the open end, an outer fabric sleeve disposed over the flexible inner tubing, a handle unitarily formed with a screwtop having an internal thread configured to mate with the threaded coupler, and an attachment mechanism coupled at a first end to the outer fabric sleeve and configured to couple to a pet's collar at a second end.

### BRIEF DESCRIPTION OF THE DISCLOSURE

Various embodiments of the presently disclosed hydrating leashes are disclosed herein with reference to the drawings, wherein:

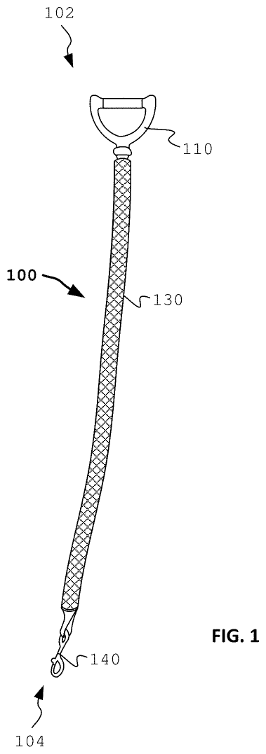

FIG. 1 is a schematic perspective view of one embodiment of a hydrating leash;

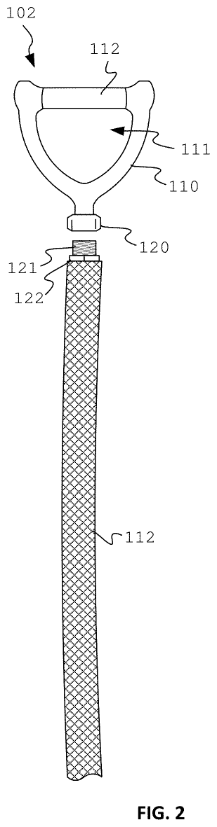

FIG. 2 is a schematic detailed view of the handle of the hydrating leash;

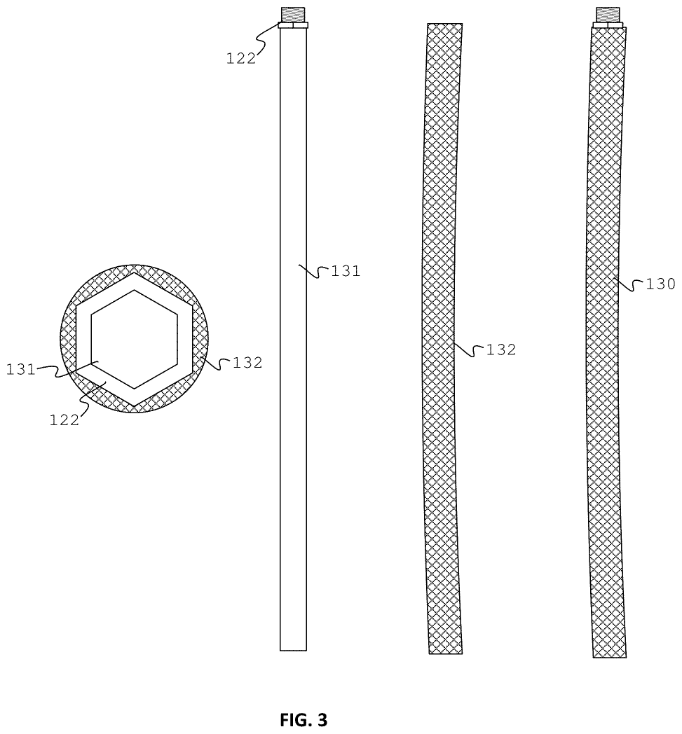

FIG. 3 are schematic views of certain components of a leash;

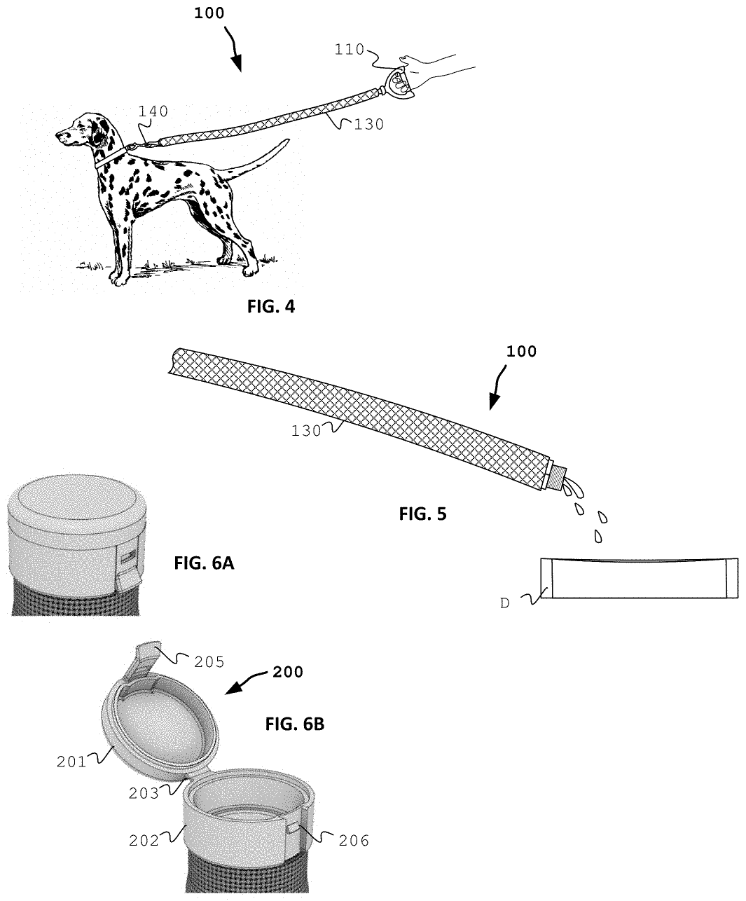

FIG. 4 is a schematic view showing the use of the leash of FIG. 1;

FIG. 5 shows water being dispensed from the hydrating leash;

FIGS. 6A-B illustrate another embodiment of the open end of the device having a tab closure;

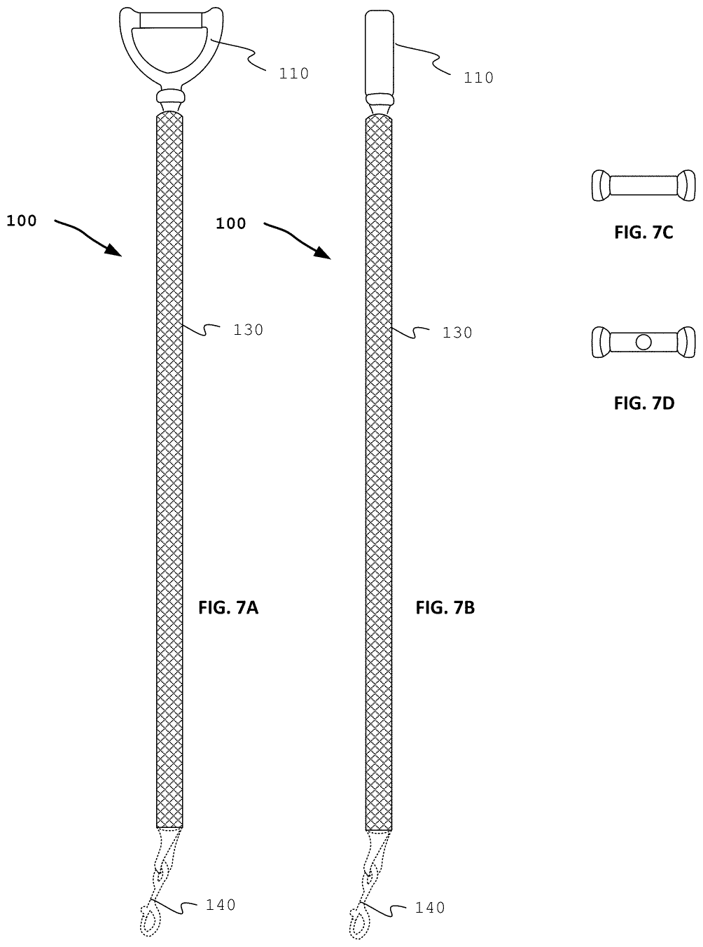

FIGS. 7A-D illustrate schematic side, top and bottom, and end views of one example of hydrating leash;

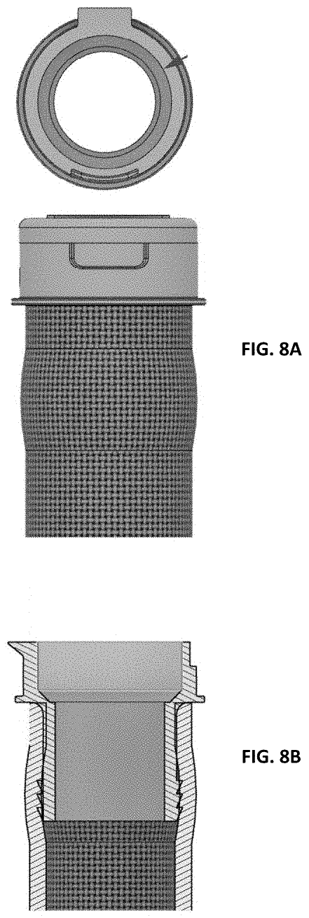

FIGS. 8A-B illustrate schematic partial side and cross-sectional views of one example of a hydrating leash; and

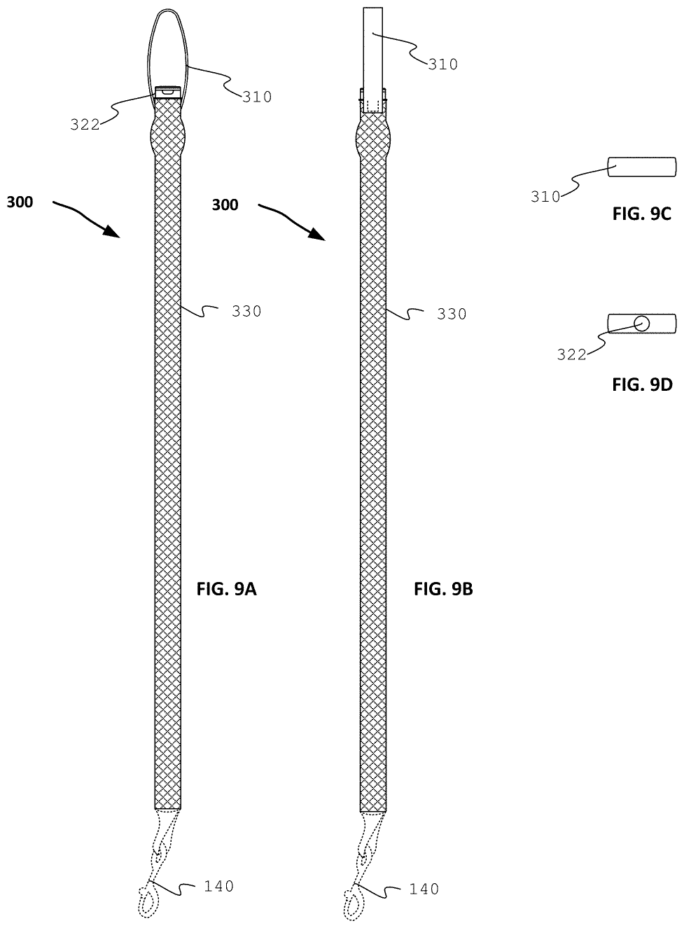

FIGS. 9A-D illustrate schematic side, top and bottom, and end views of one example of hydrating leash.

Various embodiments of the present invention will now be described with reference to the appended drawings. It is to be appreciated that these drawings depict only some embodiments of the invention and are therefore not to be considered limiting of its scope.

### DETAILED DESCRIPTION

Despite the various improvements that have been made to pet accessories, conventional devices and methods suffer from certain shortcomings such as those discussed above.

There therefore is a need for further improvements to the devices and methods used to hydrate pets. Among other advantages, the present disclosure may address one or more of these needs.

FIG. 1 is a schematic perspective view of one embodiment of a hydrating leash 100. Hydrating leash 100 generally extends between a proximal end 102 closer to the user and a distal end 104 closer to the pet. As shown, hydrating leash 100 includes a handle 110, a body 130, and a coupling mechanism 140 (e.g., a safety hook, bolt snap, boat snap or other similar attachment mechanism).

As shown in FIG. 2, handle 110 may be substantially triangular and may include an opening 111 where a user can slide his/her hand and hold onto rubber grip 112. Handle 100 may be formed of a plastic or metal and may have an ergonomic design for safe and effortless handling. A screwtop 120 is coupled to, or unitarily formed with handle 110, the screwtop 120 having an internal thread that matches with, and is configured to mate with external thread 122 on coupler 122. When screwtop 120 is securely mated with coupler 122, a fluid-tight seal is formed. Twisting the screwtop 120 relative to coupler 122 allows for quick and secure access to the liquid inside the leash body.

Turning now to FIG. 3, certain components of the leash body 130 are shown. Specifically, leash body 130 may include an inner tube 131 having a coupler 122 attached thereto at one end, and being completely sealed (i.e., closed) at a second end opposite the coupler 122. Inner tube 131 may be formed of a BPA-free, FDA-approved polymer, plastic or metal or any suitable material. For example, inner tube 131 may be formed of silicone and/or may be formed of insulating material to keep the water inside it within a reasonable drinking temperature in locations of extreme heat or extreme cold. In at least some example, tube 131 is flexible and formed of a lightweight material to allow a full range of motion and easier handling. Tube 131 may be between 24 and 48 inches in length, and may hold a volume of liquid of between 8 and 24 ounces of fluid. In at least some examples, tube 131 may hold between 12 and 16 ounces. An outer sleeve 132 formed of a fabric may be disposed about the inner tube 131 to protect it from damage, and to provide an aesthetically pleasing appearance. As shown in FIG. 3, inner tube 131 may be inserted into sleeve 132 so that only coupler 122 is exposed.

FIG. 4 is a schematic view showing the use of the leash of FIG. 1. In use, inner tube 131 may be filled with water or other liquid through coupler 122, and handle 110 may be attached to the inner tube's coupler to form a fluid-tight seal. The user may then hook the coupling mechanism 140 to the pet's collar and take the pet out for a walk. When the pet is thirsty, the user may reach for the handle and loosen it to reveal the water inside the inner tube 131. The pet may then drink out of the inner tube 131 as if from a hose (FIG. 5). Optionally, the inner tube 131 may be emptied into a cistern or dish “D”, or the user's hands.

FIGS. 6A-B illustrate another embodiment of the open end of the device having a tab closure 200 that includes a cap 201, a base 202, and a hinge 203 connecting the cap to the base. The cap 201 includes a tab 205 configured to be friction fit with a ridge 206.

FIGS. 7A-D illustrate schematic side, top and bottom, and end views of one example of hydrating leash. In this example, the hydrating leash is symmetric so that the right and left side (FIG. 7A) are the same, and the top and bottom views are the same (FIG. 7B). The end views are shown in FIGS. 7C-D.

FIGS. 8A-B illustrate schematic partial side and cross-sectional views of one example of a hydrating leash similar to that of FIGS. 6A-B. In this example, the open end has a diameter that is larger than the diameter of the inner tube which allows water to more easily flow out of the inner tube to the pet or bowl. Additionally, the open end includes a plastic molded top cap, and the inner tubing and outer sleeve may be disposed over at least a portion of the plastic molded top cap.

FIGS. 9A-D illustrate schematic side, top and bottom, and end views of one example of hydrating leash. In this example, the hydrating leash is symmetric so that the right and left side (FIG. 9A) are the same, and the top and bottom views are the same (FIG. 9B). The end views are shown in FIGS. 9C-D. As shown, hydrating leash 300 includes a leash body 330 may include an inner tube having a coupler 322 attached thereto at one end, and being completely sealed (i.e., closed) at a second end opposite the coupler 322. In this example, handle 310 is configured as a pull-strap (or loop) formed of, for example, a nylon tubular webbing fabric. The leash body 330 may include silicone, and the coupler 322 may include a plastic molded top cap.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

It will be appreciated that the various dependent claims and the features set forth therein can be combined in different ways than presented in the initial claims. It will also be appreciated that the features described in connection with individual embodiments may be shared with others of the described embodiments.

What is claimed is:

1. A hydrating leash comprising:
a flexible inner tubing having a closed end and an open end;
an outer fabric sleeve disposed over the flexible inner tubing;
a handle unitarily coupleable to the inner tubing; and
an attachment mechanism coupled at a first end to the outer fabric sleeve and configured to couple to a pet's collar at a second end.

2. The hydrating leash of claim 1, wherein the attachment mechanism comprises a boat snap.

3. The hydrating leash of claim 1, wherein the attachment mechanism comprises a safety hook.

4. The hydrating leash of claim 1, wherein the flexible inner tubing has a tubing inner diameter, and the open end defines a second diameter, the second diameter being larger than the tubing inner diameter.

5. The hydrating leash of claim 1, wherein the inner tubing terminates in a threaded coupler at the open end, and the handle comprises a screwtop having an internal thread configured to mate with the threaded coupler.

6. The hydrating leash of claim 1, wherein the inner tubing terminates in a one-piece closure mechanism.

7. The hydrating leash of claim 6, wherein the one-piece closure mechanism includes a cap and a base connected to the cap via the hinge, the cap having a tab configured to be friction fit with a ridge of the base.

8. The hydrating leash of claim 6, wherein the flexible inner tubing extends over at least a portion of the one-piece closure mechanism.

9. The hydrating leash of claim 6, wherein the outer fabric sleeve extends over at least a portion of the one-piece closure mechanism.

10. The hydrating leash of claim 6, wherein the outer fabric sleeve forms a bulge adjacent the one-piece closure mechanism.

11. The hydrating leash of claim 1, wherein the handle comprises a flexible nylon loop coupled to the outer fabric sleeve.
